(19) United States
(12) Patent Application Publication
(10) Pub. No.: US 2007/0181252 A1
(43) Pub. Date: Aug. 9, 2007

(54) Use of a hotmelt adhesive, pasty fixation compound for micro devices and detector for detecting ionizing radiation

(76) Inventors: Stefan Bohm, Schwulper (DE); Ludwig Danzer, Wendelstein (DE); Gregor Hemken, Oldenburg (DE); Jurgen Leppert, Forchheim (DE); Elisabeth Stammen, Langerwehe (DE); Jan Wrege, Wolfenbuttel (DE)

Correspondence Address: HARNESS, DICKEY & PIERCE, P.L.C., P.O.BOX 8910, RESTON, VA, 20195, US

(21) Appl. No.: 11/652,557

(22) Filed: Jan. 12, 2007

(30) Foreign Application Priority Data
Jan. 13, 2006 (DE) 10 2006 001 885.0

(51) Int. Cl. B32B 37/12

(52) U.S. Cl. 156/297; 156/327; 156/330.9; 156/331.7; 156/306.6; 156/305; 524/493

(57) ABSTRACT

Use of a hotmelt adhesive is disclosed for fixing at least one micro device on a carrier. A pasty fixation compound is further disclosed for micro devices including a powdered hotmelt adhesive, an anti-flow additive and a solvent for the anti-flow additive. Furthermore, a method is disclosed for fixing at least one micro device on a carrier, a hotmelt adhesive being applied to a carrier, the micro device being positioned at a predetermined distance from the carrier and fixed by the hotmelt adhesive until a solid adhesive bond has been produced between the at least one micro device and the carrier by cooling the hotmelt adhesive, the gap produced being filled by an epoxy resin and the two devices being adhesively bonded securely by curing of the epoxy resin. Furthermore, a detector is disclosed for detecting ionizing radiation which has a multiplicity of detector elements disposed in a two-dimensional arrangement.

### PRIORITY STATEMENT

The present application hereby claims priority under 35 U.S.C. §119 on German patent application number DE 10 2006 001 885.0 filed Jan. 13, 2006, the entire contents of which is hereby incorporated herein by reference.

### FIELD

Embodiments of the invention generally relate to the use of a hotmelt adhesive, to a pasty fixation compound for micro devices and/or to a detector for detecting ionizing radiation.

### BACKGROUND

In Microsystems technology, it is generally known to adhesively attach electronic, electromechanical, optoelectrical or purely mechanical micro devices to a substrate. Very high precision is required for this, and the small adherend surfaces, the necessity for automation of the attaching operation and the process times caused by the adhesive represent particular problems.

A projection caused by the process of attaching the micro devices means that there is a decrease in the packing density, since the distance between the micro devices and also between the components produced with them must be increased as a result of the projection. It is also intended for the attachment process to take place with cycles that are as short as possible, to allow appropriate numbers of items to be produced. Conventionally, the adhesive attachment of micro devices is performed with viscous one- or two-component systems which have a specific pot life within which the adhesive properties are retained and the adhesive attaching operation can be carried out.

Such viscous adhesives also have a specific curing time, which the adhesive requires to ensure a stable adhesive bond. The pot life should on the one hand be as great as possible, in order to make it possible for micro devices to be attached efficiently by applying the adhesive to the substrate over a large surface area and subsequently attaching a multiplicity of micro devices to the substrate in a time required for the operation. On the other hand, the pot life and the curing time should be as short as possible, in order that the adhesive bond cures immediately after the attachment and the micro devices are not displaced on the substrate. These two contrary boundary conditions can scarcely be reconciled with each other.

It is also important here that, in a wide variety of applications of microsystems technology, a defined distance has to be set between two elements to be attached to each other. This is made more difficult by the fact that the adhesive systems that are used undergo a shrinking process during curing, consequently distances that have been set cannot remain constant.

The exact positioning of micro devices is particularly important when constructing a detector for ionizing radiation, such as is used for example in computerized tomography (CT) or in positron emission tomography (PET), here specifically it also being additionally necessary to ensure that the edges of the devices are as free from adhesives as possible, since very high packing densities are necessary here. Since the number of detector elements of a detector is constantly increasing, it is also particularly important to find a low-cost method of adhesive attachment for each detector element.

For example, detectors used in computerized tomography units have a multiplicity of detector modules disposed in a one-dimensional or two-dimensional arrangement. Each of these detector modules comprises a scintillator array for X-rays adhesively bonded to a photodiode array, the two arrays having to be aligned exactly with each other in order to obtain a detector module of high quality.

Recent developments in computerized tomography have been aimed at using an ever greater number of rows for imaging. Therefore, to construct a detector, two-dimensional arrangements of individual detector modules in series are produced to form a two-dimensional detector. This presupposes an increasingly more efficient method of production for each detector element or detector module.

### SUMMARY

In at least one embodiment of the invention, a method of adhesively attaching micro devices is disclosed, which allows the adhesive attachment of a large quantity of micro devices with high precision and a high cycle rate.

Accordingly, in at least one embodiment, the inventors propose the use of a hotmelt adhesive for fixing at least one micro device on a carrier. This makes it possible for two bodies of small dimensions to be attached with high precision to each other without any projection and with a defined gap in a way that is appropriate for mounting.

A polyamide, an olefin or a polyurethane may be used for example as the hotmelt adhesive.

This use is particularly advantageous if the at least one micro device is a counting element, preferably a photodiode, for detecting ionizing radiation and the carrier on which the at least one micro device is fixed is a ceramic carrier of a detector or detector module for detecting ionizing radiation. In this way it is possible, as necessary for example for a CT detector or a PET detector, to fix a multiplicity of identical counting elements, preferably arranged in the manner of a matrix, on a ceramic carrier.

With the method described above, in at least one embodiment, it is also possible to connect two micro devices to each other by using as the carrier on which the at least one micro device is fixed a further micro device.

For a particularly advantageous use of the hotmelt adhesive, the latter may be applied to the carrier in a pasty form, preferably through a mask. A method such as that which is customary in screen printing for applying printing ink to a printing roller is used here instead for a specifically directed and dispensed application of adhesive to a carrier for receiving micro devices. This type of adhesive application makes it possible for large quantities of micro devices to be provisionally fixed very precisely on the carrier in a very short cycle time, until the final fixing of the micro device is performed by a subsequent process of underfilling the gap remaining in a defined manner between the carrier and the micro device.

Since the hotmelt adhesive is not suitable in its normal consistency for this “screen printing”-like type of application to the carrier, the inventors further propose to reconstitute the hotmelt adhesive and to use as the pasty hotmelt adhesive a mixture of hotmelt adhesive powder, an anti-flow additive to produce a thixotropic or pseudoplastic property and a solvent for the anti-flow additive which does not make the hotmelt adhesive dissolve or swell.

Alternatively, it is also proposed to place the hotmelt adhesive as a punched-out film between the micro device and the carrier, in which case the punched-out hotmelt adhesive film should cover only part of the micro device on the side to be adhesively attached.

It is also advantageous if a multiplicity of spacers of a defined size are mixed in with the hotmelt adhesive or hotmelt adhesive mixture.

Beads of an inert material with a higher melting point than the hotmelt adhesive, preferably glass beads of equal diameter, may be used as spacers. In this case, for example, beads of a certain diameter are incorporated in the hotmelt adhesive or the pasty mixture with the hotmelt adhesive, so that when the devices are attached to each other these beads lie between the approaching surfaces and ensure a minimum distance. As a result, process techniques that are less precise and consequently less costly can be used.

The inventors further propose a pasty fixation compound for micro devices which includes at least a hotmelt adhesive in powder form, an anti-flow additive for producing a thixotropic or pseudoplastic property and a solvent for the anti-flow additive which does not make the hotmelt adhesive dissolve or swell. Such a fixation compound is suitable in particular for application in connection with the “screen printing” technique. Here it is necessary that the adhesive initially has a very good flow behavior with low viscosity when it is applied through the screen area, but subsequently behaves with high viscosity and adheres to the application area.

Olefin, polyurethane or polyamide may be used for example as the hotmelt adhesive.

It is also advantageous if a combination of water as the solvent and a polymer, preferably a non-ionic polyurethane, or acryl as the anti-flow additive is used. Another combination variant is high-boiling alcohol as the solvent and fine-particled silica as the anti-flow additive.

With respect to the nature of the powder, it is favorable if the powder has grain sizes up to a maximum of 100 μm, preferably up to a maximum of 50 μm.

As already mentioned, a spacer of a defined size may be admixed as an additional constituent.

This may include, for example, glass beads of a defined uniform diameter, which corresponds to the desired gap distance.

In accordance with the fundamental principle of at least one embodiment of the invention, the inventors also propose a method of fixing at least one micro device on a carrier, the method comprising:
applying a hotmelt adhesive to a carrier, the surface area covered by the at least one micro device on the carrier only being covered partly by the hotmelt adhesive,
positioning the at least one micro device at a predetermined distance, forming a gap, from the carrier until a solid adhesive bond has been produced between the at least one micro device and the carrier by cooling the hotmelt adhesive, and
filling the gap by an epoxy resin and curing of the epoxy resin.

Therefore, with the aid of the hotmelt adhesive, the micro device is quickly and reliably attached to the carrier at a defined and unchangeable distance and, subsequently, the gap between the micro device and the carrier is filled with a durable epoxy adhesive. Such an operation of filling a gap between two devices may be accomplished for example by drawing a high-viscosity epoxy resin into the free gap between the devices by capillary action, in that a filling volume is brought into connection with the gap, so that the liquid adhesive fills the gap of its own accord.

It is particularly advantageous here that no excess adhesive escapes, and consequently devices of the same size—with respect to the adherend surfaces—can be filled without any projection. This proves to be favorable in particular when constructing detector modules, since projecting remains of adhesive would reduce the possible packing density here.

Another variant of the method according to at least one embodiment of the invention resides in that the hotmelt adhesive is produced as a film of a defined thickness and is applied to the carrier as a punched-out molded part and is fixed on the carrier by heating above the melting temperature. For this purpose, a film of the desired thickness is first produced, for example by an extrusion process known per se, and then molded parts are punched out from this film, then placed onto the micro devices or the carriers and form the adherend surface.

In a further advantageous variant, lenticular spots of adhesive can be produced from the hotmelt adhesive by melting small particles on a low-energy surface, preferably the surface of PTFE, selected with respect to their size and, depending on the desired point of adhesive attachment, a lenticular adhesive spot of a defined size fused on the surface of the carrier.

It is very favorable and efficient if the hotmelt adhesive in a pasty form is brushed on the carrier through a screen printing mask, by which the adherend areas and the areas free from adhesive are defined, and is fixed, preferably by heating. It may perhaps also be possible to dispense with the operation of heating, if the pasty adhesive is adequately viscous and the adhesive forces alone are initially adequate to produce a secure bond between the carrier and the adhesive. It goes without saying that the adhesive is then heated for fixing the micro device on the carrier, in order to achieve secure fixing between the carrier and the micro device.

As already mentioned, it is also favorable if spacers of equal size are admixed with the hotmelt adhesive or hotmelt adhesive mixture before application to the carrier, which spacers define a predetermined minimum distance between the carrier and the micro component even in the soft state of the hotmelt adhesive or the hotmelt adhesive mixture.

The at least one micro device may also be applied to the adherend surface under a predetermined pressure and at a predetermined temperature of the hotmelt adhesive, and the hotmelt adhesive subsequently cooled.

Furthermore, the at least one micro device may be brought by a sensor-guided mounting system to within a predetermined distance of the carrier at a predetermined temperature of the hotmelt adhesive, and the hotmelt adhesive cooled.

In the production process, it may also be advantageous to provide a cooling operation, which fixes the hotmelt adhesive on the surface of the carrier securely with respect to displacement before further process steps, between the fixing of the hotmelt adhesive and the application of the at least one micro device.

It should be pointed out that a further micro device may also serve as the carrier. If appropriate, this further micro device may be of the same size as the device to be adhesively attached with respect to the base area or adherend surface. Such a situation is obtained when mounting detector modules for detectors for detecting ionizing radiation in tomographic units, for example for computerized tomography.

### BRIEF DESCRIPTION OF THE DRAWINGS

The invention is described in more detail below on the basis of example embodiments with the aid of the figures, only the features necessary for understanding the embodiments of the invention being represented. The following designations are used here: 1: carrier; 2: micro device/chip; 3: suction gripper; 4: underlying surface; 5: adhesive, UV-curing; 6: needle; 7: capillary; 8: epoxy adhesive/underfiller; 9: solder bump; 10: adhesive pad; 11: chip dispenser; 12: wire; 13: hotmelt adhesive; 14: mask; 15: free areas of the mask; 16: doctor blade; 17: pasty hotmelt adhesive; 18: glass bead; 21: CT unit; 22: X-rays; 23, detector; 24: z axis/system axis; 25: gantry housing; 26: patient bench; 27: patient; 29: image computer; Prgₓ: computer programs. Specifically:

FIG. 1 to FIG. 5: show various known chip mounting sequences;

FIG. 6: shows a two-stage chip mounting process according to an embodiment of the invention;

FIG. 7: shows a three-stage chip mounting process according to an embodiment of the invention;

FIG. 8: shows a schematic representation of the application of punched-out hotmelt adhesive film to a carrier;

FIG. 9: shows a schematic representation of the application of beads of hotmelt adhesive to a carrier;

FIG. 10: shows a schematic representation of the application of a hotmelt adhesive paste to a carrier;

FIG. 11: shows a computerized tomography system with a detector mounted according to an embodiment of the invention.

### DETAILED DESCRIPTION OF THE EXAMPLE EMBODIMENTS

It will be understood that if an element or layer is referred to as being “on”, “against”, “connected to”, or “coupled to” another element or layer, then it can be directly on, against, connected or coupled to the other element or layer, or intervening elements or layers may be present. In contrast, if an element is referred to as being “directly on”, “directly connected to”, or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

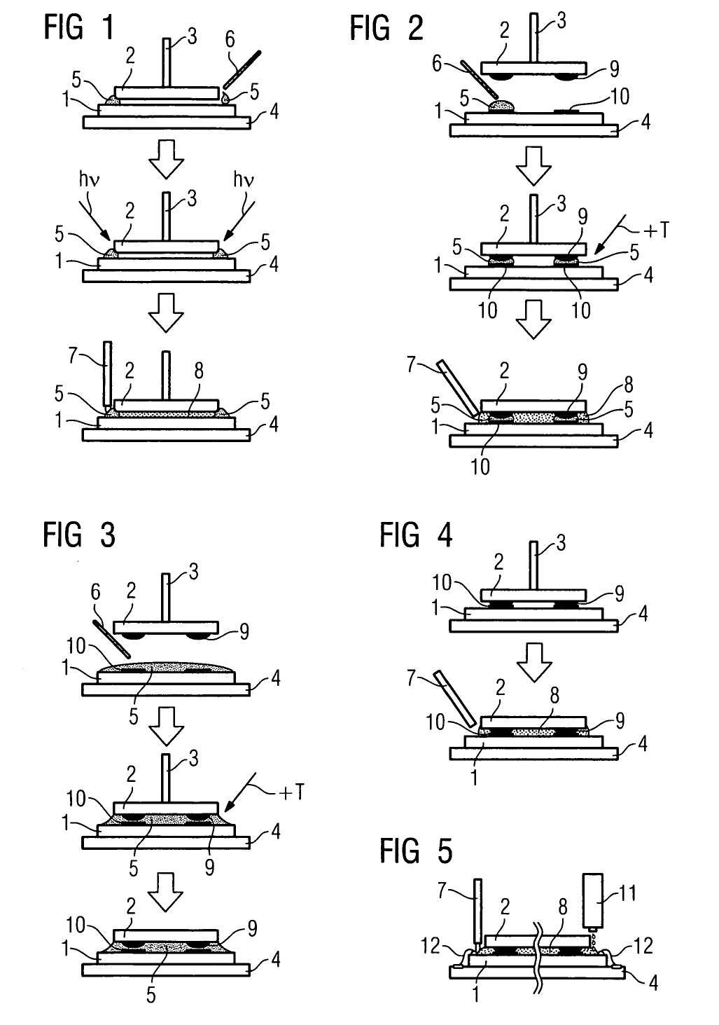

Four different known mounting sequences are presented hereafter in FIGS. 1 to 5, the variants of FIGS. 2 to 5 operating with spacers (solder bumps/pads) integrated in the device and respectively making electrical contacting possible, while in the case of FIG. 1 spacers that are independent of the device are used.

FIG. 1 shows three process steps of a known chip mounting sequence. Firstly, the chip 2 is positioned by a suction gripper 3 at the predetermined position and at the predetermined distance above the carrier 1, the setting of the distance being performed by way of spacers applied from the outside in the form of laterally applied UV-curing drops of adhesive 5. The drops of adhesive 5 are applied by a needle 6 and solidify in the second mounting step by exposure to strong UV light. Subsequently, in the third mounting step, the so-called underfilling is performed, in which a high-viscosity adhesive 8, usually multi-component epoxy resin, is introduced with the aid of a capillary 7 into the gap between the devices, where it cures.

If a defined attachment gap is required for functional reasons and does not serve for contacting (no solder areas), it can be realized by fixing in the edge region of the smaller device on the larger device, for example by the use of rapidly curing UV adhesives. However, this possibility only exists in the case of devices of different sizes that offer sufficient space for the fixing points in the region around the area of attachment. The prefixing should not adversely affect any possible active regions on the devices, for example optical or mechanically movable elements.

A similar mounting method is shown in FIG. 2, but here the setting of the distance is performed by way of solder bumps 9 and solder pads 10 in conjunction with isotopically conductive adhesive 5 which is applied between them in a punctiform manner, likewise by a dispersing needle 6 between solder bump 9 and solder pad 10. In the last step, the underfilling process is again performed, finally bonding the micro device or the chip 2 to the carrier. This technique is referred to as ICA adhesive bonding (ICA=Isotropic Contact Adhesive).

FIG. 3 shows in a modification of the method from FIG. 2 the setting of the distance by means of solder bumps and solder pads, an anisotropically conductive adhesive being applied however over the full surface area between the carrier 1 and the chip 2 and curing by exposure to heat. The solder bumps and pads determine the distance during attachment until the adhesive has solidified as a result of the temperature increase. This technique is known as ACA adhesive bonding (ACA=anisotropic contact adhesive).

Finally, FIG. 4 shows the setting of the distance by way of a soldering process with a subsequent process of underfilling the free gap. In this process known as a “flip chip mounting process”, the flip chips 2, that is say the micro devices, are generally soldered on a leadframe 1, the dimensions of which exceed the device size of the chip 2. By this precise dispensing of the solder paste, a defined attachment gap can be set between the carrier 1 and the chip 2. The subsequent underfilling of the device is shown once again in a larger representation in FIG. 5. Here, the calculated adhesive volume is applied to the leadframe on one or more sides of the device. The dispensing is performed, as represented by way of example on the right-hand side, by a jet dispenser 11 or, according to the representation on the left, by a dispensing needle 7 and a dispensing system not shown in any more detail here.

For exact gap setting between the micro device 2 and the carrier 1, all these methods from FIGS. 1 to 5 either require very precisely configured process mechanics or distance-defining solder bumps 9 and solder pads 10 have to be already attached to the micro device or carrier. High-precision process mechanics are very complex and are also not usually suitable for high cycle rates, and it is not advisable in the case of all micro devices to attach solder bumps and solder pads.

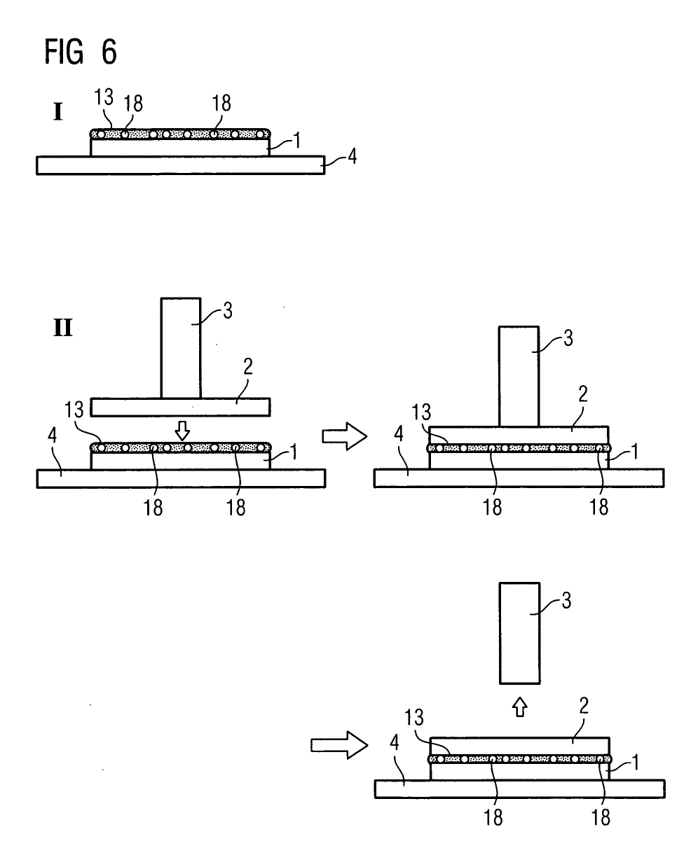

The following FIGS. 6 et seq show variants of the method according to an embodiment of the invention, which are all based on the use of a hotmelt adhesive for the quick and easy first fixing of the micro devices on a carrier.

In principle, it is possible to fix micro devices that are not exposed to high thermal loads during operation on a carrier with hotmelt adhesive exclusively and, if appropriate, over the full surface area. In this case, the attachment gap is not set by spacers integrated in the device but by the hotmelt adhesive, so that the devices can be planar. Additional working steps are no longer needed for producing the spacers. Hotmelt adhesives are used for setting the gap and/or for fixing the devices.

FIG. 6 shows a two-stage process with the process stages I and II, in which the entire surface area for adhesive attachment of a carrier 1 is covered with hotmelt adhesive 13. For example, a punched-out piece of film of adhesive may be used for this purpose. After that, the devices 1 and 2 are attached to each other, the fixing with respect to each other and the gap setting being performed by way of the hotmelt adhesive 13. According to an embodiment of the invention, glass beads 18 of defined diameters may for example be additionally incorporated in the adhesive 13, whereby greatly simplified distance setting is made possible.

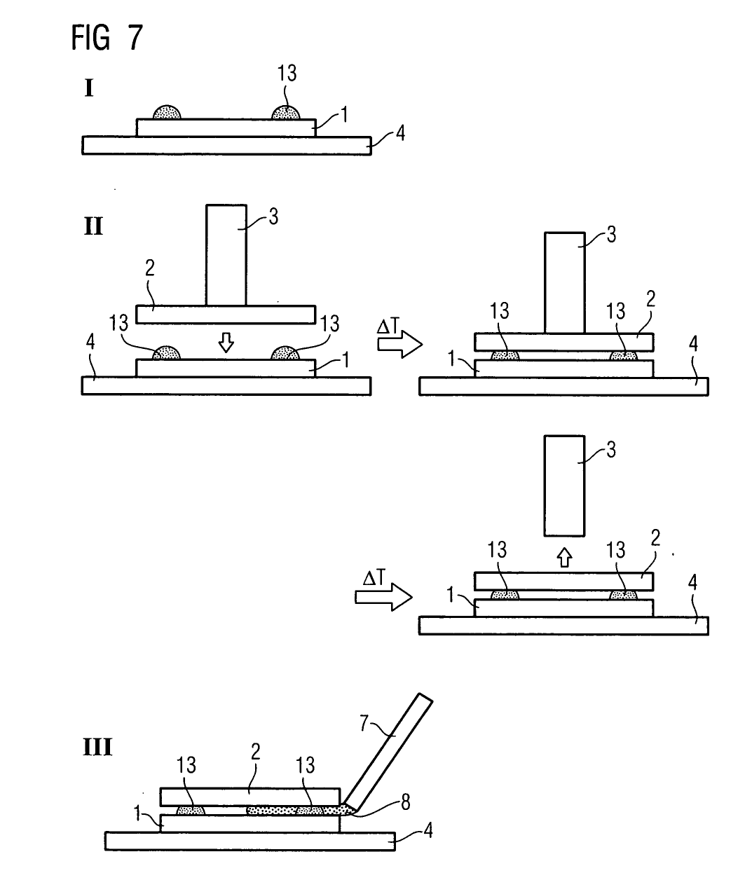

FIG. 7 shows the sequence of a three-stage process with the process stages I to III. Here, in the mounting step I, the hotmelt adhesive 13 is first applied in the form of spots to predetermined areas on the carrier 1, after that, in mounting step II, the devices are attached to each other, the first fixing with respect to each other being performed by way of the hotmelt adhesive 13. This first fixing is very precise and, as a result of the use of the hotmelt adhesive, is not subject to any changes over time caused by “curing”. The complete filling of the device gap is performed in mounting step III by an underfilling process in which a low-viscosity, pasty adhesive 8 is applied by a dispensing needle 7 into the gap between the micro device 2 and the carrier 1.

In an application of this method in the area of mounting detector elements, it should be ensured that the hotmelt adhesive that is used for the fixing and the adhesive that is used for the underfilling do not chemically influence each other. This would passivate the active surfaces of the detector arrays and thereby make them unusable.

By suitable thermal process control, the positioning/fixing process is significantly quicker in comparison with other fixing methods, such as for example the process explained above using UV-curing systems.

The applied adhesives may be electrically or thermally conductive or else insulating. By contrast with the ACA method, the setting of the attachment gap is not performed by means of solder bumps as spacers or pads, but instead the adhesive is so highly viscous and quick-setting that the fixing is performed by the conductive adhesive points and highly precise gap setting is performed by means of a sensor-guided mounting system. It is consequently possible to dispense with the application of additional solder bumps and the gap setting becomes independent of production possibilities and device tolerances.

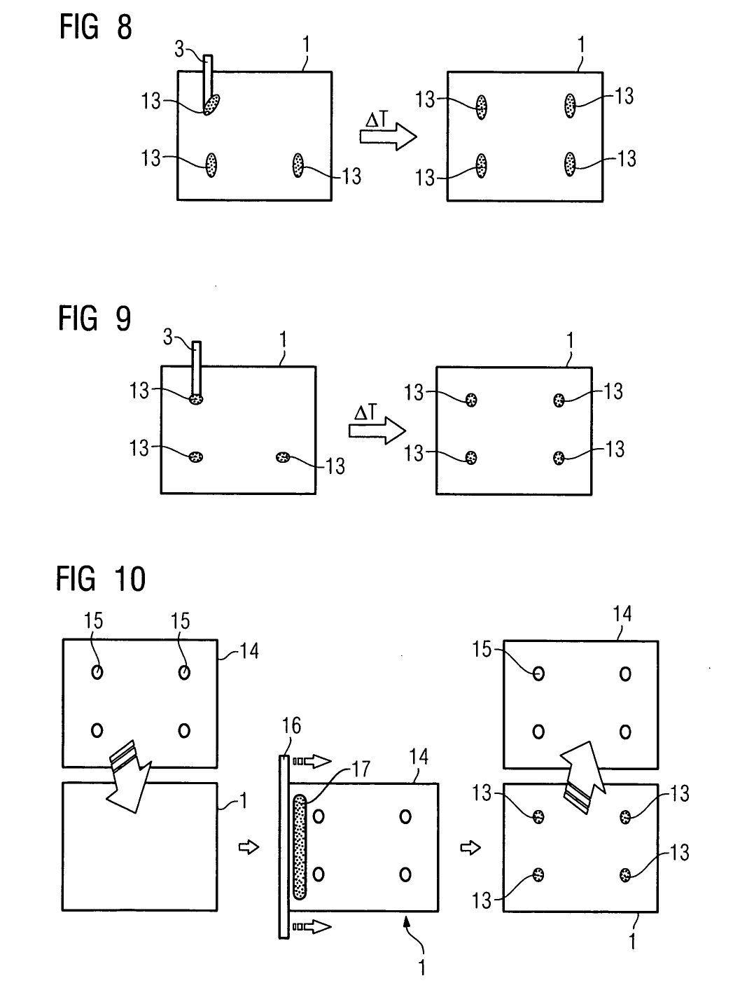

In FIGS. 8 to 10, the different methods of applying the hotmelt adhesive to a carrier are represented. By way of example, application may take place in the form of a film of a defined thickness and size, as a bead of adhesive or lenticular spot of adhesive—re-melted from adhesive particles—or in the form of an adhesive particle dispersion. By contrast with the use of viscous adhesive systems, the dispensing of small amounts of hotmelt adhesive is easier. This makes it possible also to dispense and position the required hotmelt adhesive exactly onto extremely small available areas.

FIG. 8 shows the application of the hotmelt adhesive by using a hotmelt adhesive film. Films of a defined thickness can be produced from many hotmelt adhesives at temperatures of 175-250° C. using a blown-film extruder. For this purpose, the films of the desired thickness may be punched out by a suitable tool and ejected. With a gripper, generally a suction gripper, the contoured film pieces 13 are gripped and positioned on the carrier 1. The film pieces are configured here as simple ellipsoids, but it goes without saying that much more complex formations can be used if need be. The adhesive is subsequently fixed on the surface by heating to the melting temperature of the adhesive. The micro device can then be applied in a defined manner and preferably then permanently fixed by an underfilling process.

In FIG. 9, the use of beads or lenticular spots of hotmelt adhesive is represented. For this purpose, lenticular spots of adhesive, or in the ideal case beads of adhesive, are produced by remelting the usually broken, i.e. irregularly formed, hotmelt adhesive particles on a low-energy surface, such as for example PTFE or Teflon®. After cooling, these spots or beads can be homogenized by filtering. The beads 13 of the desired size can then be picked up by a suction gripper 3, positioned, set down and fixed on the surface of the carrier 1 or micro device by fusing.

For mounting, the micro device can then be attached together with the carrier under a defined pressure and defined temperature, so that a gap of a defined size is produced. Here, too, small spacers may be integrated in the hotmelt adhesive, not allowing the distance between the micro device and the carrier or between two micro devices to go below a minimum. Finally, an underfilling process may be performed.

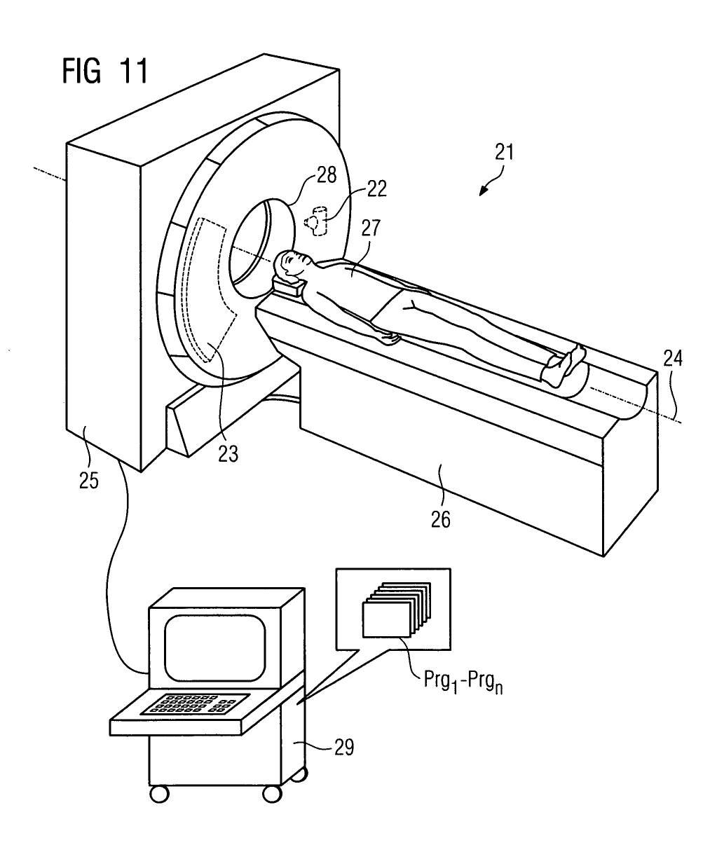

The preferred use of adhesive particle dispersions for the exactly defined fixing of micro devices is represented in FIG. 10. The application of the hotmelt adhesive dispersion is performed by a masking process. For this purpose, a mask 14 of a specific thickness with openings 15 is placed onto a carrier 1. A pasty adhesive dispersion 17 including pulverized hotmelt adhesive with homogeneous particle size distribution, an anti-flow additive and a solvent for the anti-flow additive is spread over the mask lying on the carrier by a doctor blade 16, the thickness of the mask 14 determining the thickness of the adhesive. After the application, the solvent can evaporate and the adhesive particles remaining behind can be re-melted. Depending on the viscosity properties of the pasty adhesive, the mask 14 may be used before or after the fusing.

The mounting process may be advantageously interrupted here after the application of the hotmelt adhesive and resumed at a later point in time. In this case, the micro device is initially fixed on the surface of the carrier by brief fusing of the hotmelt adhesive and is permanently adhesively bonded by a downstream underfilling process.

In order to obtain particularly good wetting, necessary in the underfilling process, between the adhesive, the devices and also the hotmelt adhesive that is used, the surface to be wetted may be activated by a suitable surface pretreating process, for example low-pressure plasma. To set the attachment gap, the hotmelt adhesive is then melted on the precoated substrate. Then, the element to be attached is positioned on the precoated substrate in such a way that the desired attachment gap is set.

For this purpose, the amount of hotmelt adhesive is predefined in such a way that adequate wetting of the devices and an adequately great final strength of the adhesive bond is achieved. By suitable temperature control, the hotmelt adhesive is cooled and immediately reaches its final strength. The devices are then fixed with respect to one another in all dimensions. The process can be interrupted here and resumed at a later point in time.

At least one of the following advantages are made possible by the method according to at least one embodiment of the invention described above:
projection-free attachment of small devices with a defined gap in a way that is appropriate for mounting;
dispensing of extremely small amounts of adhesive;
positioning with great accuracy on extremely small available areas;
rapid process sequences;
splitting of the individual method steps (preapplication, fixing/attaching, underfilling);
fixing and adhesive bonding without impairing active areas.

This method is suitable in particular for the mounting of large-area detectors which are made up of a multiplicity of individual detector elements comprising micro devices, it being particularly advantageous that subgroups of detector elements can initially be constructed to form detector modules, which are subsequently attached to one another to form a detector constructed from a number of detector modules.

Such a detector of a modular construction may be used for example in an X-ray CT system, an X-ray C-arc unit or else a PET system. A CT system which has a detector constructed according to the invention is shown by way of example in FIG. 11.

The computerized tomography unit 21 represented in a schematic way in FIG. 11 includes an X-ray source 22, in a way known per se. The X-ray beam emanating from the focus of the X-ray source (not explicitly represented) is made to take a fanned-out or pyramid-shaped form by diaphragms. The x-ray beam penetrates an object to be examined, here a patient 27—located on a patient bench 26—and impinges on the detector 23 constructed from the detector modules.

The detector 23 includes a multiplicity of detector rows lying next to one another and running in the form of an arc in the circumferential direction. The detector rows are arranged one behind the other in the z direction. During operation of the computerized tomography unit 21, the X-ray source 22 and the detector 23 rotate in a gantry housing 25 around the object being examined 27, the absorption data of the object that is being examined being obtained at regular intervals from different directions of projection. From the projection data determined with the detector 23, an image computer 29 subsequently uses computer programs Prgₓ, in a way known per se to reconstruct one or more two-dimensional or three-dimensional images of the object being examined, which can be presented on a visual display unit.

It goes without saying that the aforementioned features of embodiments of the invention can be used not only in the combination respectively specified, but also in other combinations or on their own without departing from the scope of the invention.

Altogether, at least one embodiment of the invention therefore proposes the use of a hotmelt adhesive for fixing at least one micro device on a carrier and a pasty fixation compound for micro devices comprising a powdered hotmelt adhesive, an anti-flow additive and a solvent for the anti-flow additive. Also proposed are a method of fixing at least one micro device on a carrier, a hotmelt adhesive being applied to a carrier, the micro device positioned there at a predetermined distance from the carrier and fixed by the hotmelt adhesive until a solid adhesive bond has been produced between the at least one micro device and the carrier by cooling the hotmelt adhesive, the gap produced being filled by an epoxy resin and the two parts adhesively bonded securely by curing of the epoxy resin, and a detector for detecting ionizing radiation which has a multiplicity of detector elements disposed in a two-dimensional arrangement and has been produced by this method.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method, comprising:
using a hotmelt adhesive for fixing at least one micro device on a carrier.

2. The method as claimed in claim 1, wherein the hotmelt adhesive is a polyamide.

3. The method as claimed in claim 1, wherein the hotmelt adhesive is an olefin.

4. The method as claimed in claim 1, wherein the hotmelt adhesive is a polyurethane.

5. The method as claimed in claim 1, wherein the at least one micro device is a counting element for detecting ionizing radiation.

6. The method as claimed in claim 1, wherein the carrier on which the at least one micro device is fixed is a ceramic carrier of at least one of a detector and detector module for detecting ionizing radiation.

7. The method as claimed in claim 5, wherein a multiplicity of identical counting elements are fixed on a ceramic carrier.

8. The method as claimed in claim 1, wherein the carrier, on which the at least one micro device is fixed, is a further micro device.

9. The method as claimed in claim 1, wherein the hotmelt adhesive is applied in pasty form.

10. The method as claimed in claim 1, wherein a mixture of hotmelt adhesive powder, an anti-flow additive to produce at least one of a thixotropic and pseudoplastic property and a solvent for the anti-flow additive which does not make the hotmelt adhesive at least one of dissolve and swell, is used as the pasty hotmelt adhesive.

11. The method as claimed in claim 1, wherein the hotmelt adhesive is placed as a punched-out film between the micro device and the carrier.

12. The method as claimed in claim 11, wherein the punched-out hotmelt adhesive film covers only part of the micro device on the side to be adhesively attached.

13. The method as claimed in claim 1, wherein a multiplicity of spacers of a defined size are admixed with the hotmelt adhesive.

14. The method as claimed in claim 13, wherein beads of an inert material with a higher melting point than the hotmelt adhesive are used as spacers.

15. A pasty fixation compound for micro devices comprising at least the following constituents:
a powdered hotmelt adhesive;
an anti-flow additive for producing at least one of a thixotropic and pseudoplastic property; and
a solvent for the anti-flow additive which does not make the hotmelt adhesive dissolve and which does not make the hotmelt adhesive swell.

16. The pasty compound as claimed in claim 15, wherein the hotmelt adhesive is an olefin.

17. The pasty compound as claimed in claim 15, wherein the hotmelt adhesive is a polyurethane.

18. The pasty compound as claimed in claim 15, wherein the hotmelt adhesive is a polyamide.

19. The pasty compound as claimed in claim 15, wherein the solvent is water and the anti-flow additive is a polymer.

20. The pasty compound as claimed in claim 15, wherein the solvent is a high-boiling alcohol and the anti-flow additive is a fine-particled silica.

21. The pasty compound as claimed in claim 15, wherein the powder has grain sizes up to a maximum of 100 μm.

22. The pasty compound as claimed in claim 15, wherein the pastry compound includes admixed spacers of a defined size as an additional constituent.

23. The pasty compound as claimed in claim 22, wherein the spacers are glass beads of a specific diameter.

24. A method of fixing at least one micro device on a carrier, the method comprising:
applying a hotmelt adhesive to a carrier, the surface area covered by the at least one micro device on the carrier only being covered partly by the hotmelt adhesive;
positioning the at least one micro device at a predetermined distance, forming a gap, from the carrier until a solid adhesive bond has been produced between the at least one micro device and the carrier by cooling the hotmelt adhesive; and
filling the gap by an epoxy resin and curing of the epoxy resin.

25. The method as claimed in claim 24, wherein the hotmelt adhesive is produced as a film of a defined thickness and is applied to the carrier as a punched-out molded part and is fixed on the carrier by heating above the melting temperature.

26. The method as claimed in claim 24, wherein lenticular spots of adhesive can be produced from the hotmelt adhesive by melting small particles on a low-energy surface selected with respect to their size and, depending on the desired point of adhesive attachment, a lenticular adhesive spot of a defined size fused on the surface of the carrier.

27. The method as claimed in claim 24, wherein the hotmelt adhesive in a pasty form is brushed on the carrier through a screen printing mask, by which the adherend areas and the areas free from adhesive are defined, and is fixed.

28. The method as claimed in claim 24, wherein spacers of equal size are admixed with at least one of the hotmelt adhesive and hotmelt adhesive mixture before application to the carrier, the spacers defining a minimum distance between the carrier and the micro device, even in the soft state of at least one of the hotmelt adhesive and the hotmelt adhesive mixture.

29. The method as claimed in claim 24, wherein the at least one micro device is applied to the adherend surface under a predetermined pressure and at a predetermined temperature of the hotmelt adhesive, and the hotmelt adhesive is cooled.

30. The method as claimed in claim 24, wherein the at least one micro device is brought by a sensor-guided mounting system to within a predetermined distance of the carrier at a predetermined temperature of the hotmelt adhesive, and the hotmelt adhesive is cooled.

31. The method as claimed in claim 24, wherein a cooling operation, which fixes the hotmelt adhesive on the surface of the carrier securely with respect to displacement before further process steps, is provided between the fixing of the hotmelt adhesive and the application of the at least one micro device.

32. The method as claimed in claim 24, wherein a further micro device serves as the carrier.

33. A detector for detecting ionizing radiation, comprising:
a multiplicity of detector elements, disposed in a two-dimensional arrangement and defining a local resolution of the detector, the detector elements being constructed from a pasty fixation compound comprising at least the following constituents:
a powdered hotmelt adhesive;
an anti-flow additive for producing at least one of a thixotropic and pseudoplastic property; and
a solvent for the anti-flow additive which does not make the hotmelt adhesive dissolve and which does not make the hotmelt adhesive swell.

34. The method as claimed in claim 5, wherein the counting element is a photodiode.

35. The method as claimed in claim 7, wherein the multiplicity of identical counting elements are arranged in a matrix.

36. The method as claimed in claim 9, wherein the hotmelt adhesive is applied in pasty form through a mask.

37. The method as claimed in claim 14, wherein beads are glass beads of equal diameter.

38. The pasty compound as claimed in claim 19, wherein the polymer is at least one of a non-ionic polyurethane and acryl.
